(19) United States
(12) Patent Application Publication
(10) Pub. No.: US 2024/0084932 A1
(43) Pub. Date: Mar. 14, 2024

(54) FUNCTIONALIZED THERMOPLASTIC COMPOSITE LAYER FOR THE PRODUCTION OF PIPES AND PRESSURE VESSELS

(71) Applicants: SAUDI ARABIAN OIL COMPANY, Dhahran (SA); King Abdullah University of Science and Technology, Thuwal-Jeddah (SA)

(72) Inventors: Sanjay Rastogi, Thuwal (SA); Joris Van der Eeem, Thuwal (SA); Dario Romano, Thuwal (SA); Abderrazak Traidia, Lussan (FR)

(73) Assignees: SAUDI ARABIAN OIL COMPANY, Dhahran (SA); King Abdullah University of Science and Technology, Thuwal-Jeddah (SA)

(21) Appl. No.: 17/931,611

(22) Filed: Sep. 13, 2022

(51) Int. Cl. F16L 9/128; B32B 7/12; B32B 27/08; B32B 27/12; B32B 27/32; B32B 27/36

(52) U.S. Cl. CPC F16L 9/128; B32B 7/12; B32B 27/08; B32B 27/12; B32B 27/32; B32B 27/36; B32B 2262/0246; B32B 2270/00; B32B 2274/00; B32B 2307/306; B32B 2307/54; B32B 2307/718; B32B 2307/7242; B32B 2367/00; B32B 2597/00

(57) ABSTRACT

A reinforced thermoplastic composite pipe or pressure vessel may include an elongate tubular body that has an outer surface, and at least one reinforcement layer disposed on the outer surface of the elongate tubular body. The reinforcement layer may include one or more layers of ultra-high molecular weight polyethylene (UHMWPE) tape. The UHMWPE tape may be a composite that includes multiple UHMWPE film layers. A method of forming a reinforced thermoplastic composite pipe may include extruding an elongate tubular body having an outer surface, wrapping at least one reinforcement layer on the outer surface of the elongate tubular body, and positioning a cover layer as the outermost layer.

### FIELD OF THE DISCLOSURE

Embodiments of the present disclosure generally relate to thermoplastic composite pipes and pressure vessels.

### BACKGROUND

Thermoplastic composite pipes and pressure vessels are commonly used for fluid transportation applications, including offshore oil and gas production. Thermoplastic composite pipes and pressure vessels are corrosion-free, more economic than carbon steel pipes and vessels when considering the product lifecycle, easily installable, and have faster well tie-ins and improved integrity. Thermoplastic composite pipes and pressure vessels generally include several layers of material where a reinforcement material is wound around an extruded liner, and a thermoplastic cover is extruded over the reinforcement layer. Thermoplastic composite pipes and pressure vessels can consist of at least three layers: an internal polymeric liner, a reinforced pressure containment, and an outer polymeric cover. After production, thermoplastic composite pipes may be spooled in reels and shipped in a truck loading to the field for installation. Generally, in thermoplastic composite pipes and pressure vessels, all of the layers are melt-fused together to create a fully bonded structure. Thermoplastic composite pipes are normally qualified in accordance with DNVGL-ST-F119 requirements.

Although the use of thermoplastic composite pipes and pressure vessels have mostly been limited to water applications in the oil and gas industry, these types of pipes and pressure vessels are increasingly being introduced to fields where hydrocarbons are present with a high level of water cut in addition to hydrogen sulfide, carbon dioxide, and methane mixtures. Among the different pipe technologies deployed in the oil and gas industry, thermoplastic composite pipes and pressure vessels are currently considered a product of choice for oil and gas flowlines (parameters include up to 6 inches of diameter, 1500 pounds per square inches, and 180° F.) and water injection lines (parameters include up to 10 inches of diameter, 3000 pound per square inches, and 185° F.). This is mainly due to the thermoplastic composite pipes and pressure vessels' corrosion-free aspect, better economics over carbon steel pipes when considering the product lifecycle, easy installation, faster well tie-ins, and improved integrity. However, such thermoplastic composite pipes and pressure vessels are limited in terms of their nominal size, as well as their temperature and pressure ratings, which may result in significant operational limitations in terms of performance or cost.

Compared to conventional pipe technologies, thermoplastic composite pipes and pressure vessels have a relatively limited operating envelope in terms of nominal size, temperature, and pressure ratings. In particular, thermoplastic composite pipes and pressure vessels have been limited in terms of their temperature rating and their mechanical properties, such as modulus and strength, when exposed to aromatic components at high temperatures. Further, while polyethylene polymers have also been used in the liner layer of thermoplastic composite pipes and steel pipes, and pressure vessels, these liner layers exhibited lower physical and mechanical properties when exposed to higher temperatures. Such liner layers also resulted in aromatic hydrocarbon uptake when exposed to aromatic components as well as permeation when used in sour environments. Similarly, the swelling and plasticization effects of polyethylene polymers used in liners in polymer-lined carbon steel pipes used in the presence of aromatic crude or the permeation and resulting corrosion effects of such polymer-lined carbon steel pipes limit their maximum allowable operating temperatures or require costly material upgrades. The majority of the commercial pipeline and storage products are manufactured using raised temperature PE (PE-RT) as a matrix and Glass or Aramid fibers as a reinforcement. This limitation in temperature, pressure, and size is fairly well known to be related to the steep degradation in mechanical properties (modulus and strength) of PE (and PE-RT) polymeric matrix when exposed to aromatic components at high temperatures (>180° F.) in addition to a significant creep degradation of typical E or ECR glass fiber reinforcements at high temperatures and high-stress levels.

### SUMMARY OF THE CLAIMED EMBODIMENTS

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a reinforced thermoplastic composite pipe or pressure vessel. The reinforced thermoplastic composite pipe or pressure vessel may include an elongate tubular body that has an outer surface, and at least one reinforcement layer disposed on the outer surface of the elongate tubular body. The reinforcement layer may comprise one or more layers of ultra-high molecular weight polyethylene (UHMWPE) tape. The UHMWPE tape may be a composite that includes multiple UHMWPE film layers.

In another aspect, embodiments disclosed herein relate to a method of forming a reinforced thermoplastic composite pipe. The method may include extruding an elongate tubular body having an outer surface, wrapping at least one reinforcement layer on the outer surface of the elongate tubular body, and positioning a cover layer as the outermost layer. The reinforcement layer may include one or more layers of ultra-high molecular weight polyethylene (UHMWPE) tape. The UHMWPE tape may be a composite that includes multiple UHMWPE films.

Other aspects and advantages will be apparent from the following description and the appended claims.

### BRIEF DESCRIPTION OF DRAWINGS

FIG. 1 shows a schematic representation of the general construction of a composite pipe in accordance with one or more embodiments.

FIG. 2 shows a schematic representation of a reinforcement layer structure of a composite pipe or pressure vessel in accordance with one or more embodiments.

FIG. 3 shows a schematic representation of a tape structure of a composite pipe or pressure vessel in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Fluid transport systems use conduits such as pipelines to transport the fluids over long distances or between processing and storage devices. Herein, the term “fluid” is used to describe a substance that has no fixed shape and yields easily to external pressure, and, as such, the term “fluid” may be referring to gases, liquids, slurries, or a combination of two or more of these. The fluids that may be transferred within the pipeline systems, or contained in pressure vessels, according to embodiments herein may include crude oil/wild crude, dry gas, wet gas, water, etc. Gas can be natural gas such as methane, LPG such as propane and butane, hydrogen, helium, carbon dioxide, etc.

Embodiments herein generally relate to composite pipes and pressure vessels. More specifically, embodiments herein relate to composite pipes and pressure vessels including an internal liner, a reinforcement layer, and a cover or sheath layer (optional). Embodiments herein also relate to methods of manufacturing such composite pipes and pressure vessels. In some embodiments, the composite pipes may be spoolable composite pipes.

The reinforcement layer may be wound around the internal liner to provide structural support to the internal liner. The reinforcement layer in other embodiments may provide structural support as well as other optional functionality for the resulting pipe or pressure vessel.

The reinforcement layer may include one or more layers of ultra-high molecular weight polyethylene (UHMWPE) tape, including self-reinforced UHMWPE tapes. Further, each of the one or more layers of UHMWPE tape may be formed from one or more UHMWPE film layers. The film layers and the tape layers may further include functional material or bonding material.

In some embodiments, the reinforcement layer may include two or more layers of ultra-high molecular weight polyethylene (UHMWPE) tape, including self-reinforced UHMWPE tapes. Further, each of the one or more layers of UHMWPE tape may be formed from one or more UHMWPE film layers. The film layers and the tape layers may further include functional material or bonding material. As an example, a first tape can be wound around the internal liner and a second tape can be wound around on top, such as at an angle or shifted relative to the first tape. The layers of tape form a single reinforcement layer. In another example, the first and second tape can also be wrapped around in a woven manner to form a single reinforcement layer.

FIG. 1 shows a schematic representation of the general construction of a composite pipe or pressure vessel 100 in accordance with one or more embodiments. The multi-layered composite pipe or pressure vessel 100 may include an inner extruded tubular liner or a liner layer 101, a reinforcement layer 102 surrounding the inner extruded tubular liner or liner layer 101, and an outer extruded tubular sheath or cover layer 103 surrounding the reinforcement layer 102. However, in one or more embodiments, the composite pipe or pressure vessel 100 may be of more complex or less complex geometry.

The composite pipe as illustrated in FIG. 1 may be formed by extruding the liner, wrapping the reinforcement layer(s) over the liner, then jacketing the reinforced liner with the cover layer. Other layers intermediate the inner liner and the cover layer may also be included if desired. Formation of the composite pipe may also include heating, such as to bond or consolidate two or more of the layers, followed by cooling and spooling of the composite pipe. The manufacturing process of the thermoplastic composite pipes or pressure vessels according to some embodiments herein may be a continuous process that may involve three main distinct phases. The first phase may be the extrusion of the polymeric liner pipe to the required dimension, the second phase may be the winding of the reinforcement material around the extruded liner at a specific orientation and thickness followed by heat consolidation for bonded systems, and the third phase may be an extrusion of the thermoplastic cover on the reinforcement layer. After production, thermoplastic composite pipes according to embodiments herein are spooled in reels, then shipped to the field for installation.

Each of the structural layers of the composite pipes and pressure vessels according to embodiments herein, including the internal liner, the reinforcement layer, and optionally the cover layer, optionally the functional or bonding materials, and methods for forming the composite pipes and pressure vessel are described further below.

### Internal Liner

Internal liners according to embodiments herein may be formed from natural or synthetic rubbers or other man-made polymers as known in the art. The polymers used to form the internal liners or an innermost layer thereof may be selected based on the properties of the material to be conveyed or handled in the composite pipes and pressure vessels according to embodiments herein.

The internal liner may include a polymeric material such as a thermoplastic. In some embodiments, internal liners useful in embodiments herein may be formed from polyethylene (Ultra High Molecular Weight Poly-Ethylene, High-Density PE, Medium Density PE, PE, PE-copolymers, etc.), polypropylene or polypropylene copolymers, polyamides such as PA 6, PA11 and PA12, and other various thermoplastics, preferable being a high-density polymer. In other embodiments, internal liners useful in embodiments herein may be formed from polyvinyl fluoride, polytetrafluoroethylene, polyimides, polyketones, polyetheretherketone, polyvinyl chloride, chlorinated polyvinyl chloride, but are not limited to those mentioned examples. Thermoplastic materials can have a uniform nature or a molecular orientation.

In one or more embodiments, the internal liner may be extruded and may have a pipe thickness (outside diameter minus inside diameter). The thickness of the internal liner may be at least 0.5 mm. The thickness of the internal liner may be in the range from about 0.5 mm to about 10 mm, for example. In some embodiments, the thickness of the internal liner may be in the range from about 2 mm to about 9 mm. The thickness of the internal liner may be in the range from about 6.5 mm to about 8 mm in other embodiments. In one or more embodiments, the outer diameter of the internal liner may be in the range from about 1 inch to about 24 inches. Pressure vessels may have similar liner thicknesses, with diameters that may be at least 1 inch. Pressure vessels may have similar liner thicknesses, with diameters that may be in the range from 1 inch to 60 inches, for example. For both pipes and pressure vessels, the thickness of the internal liner may depend upon the desired pressure rating, the composition of the liner, the reinforcement layer properties, and other factors known to one skilled in the art.

The tubular internal liner may be extruded, following which the tube may be spooled on a reel for subsequent processing or, following extrusion, may be further processed by adding the additional layers of the pipe, such as by wrapping one or more reinforcement layers and disposing of a cover layer over the internal liner.

### Reinforcement Layer

As noted above, each reinforcement layer may include one or more layers of ultra-high molecular weight polyethylene (UHMWPE) tape. Further, such UHMWPE tape may be formed from one or more UHMWPE film layers. The film layers and the tape layers may further include functional material or bonding material.

For a non-limiting example, a first UHMWPE tape may be wound around the internal liner of the composite pipe and a second UHMWPE tape may be wound around on top, preferably at an angle or shifted. Therefore, the first layer may be a reinforcement layer consisting of one UHMWPE tape in accordance with one or more embodiments. For another non-limiting example, the first UHMWPE tape, and the second UHMWPE tape may be wrapped around in a woven manner to form a single reinforcement layer in accordance with one or more embodiments.

In some instances, the reinforcement layer may be used as a permeation barrier and may eliminate the requirement of having an inner liner in a composite pipe or pressure vessel.

### Reinforcement Structure

Each reinforcement layer of the reinforcement structure may include one or more layers of UHMWPE tape. The tape layers may be bonded or unbonded, including self-bonding tape layers or tape provided with a bonding material disposed on one or both primary surfaces of a tape layer or intermediate two or more of the tape layers. Similarly, a functional material or a plurality of functional materials may be provided within a tape layer or between tape layers, or both. The functional material present in the reinforcement layer may allow self-healing properties to the inner liner.

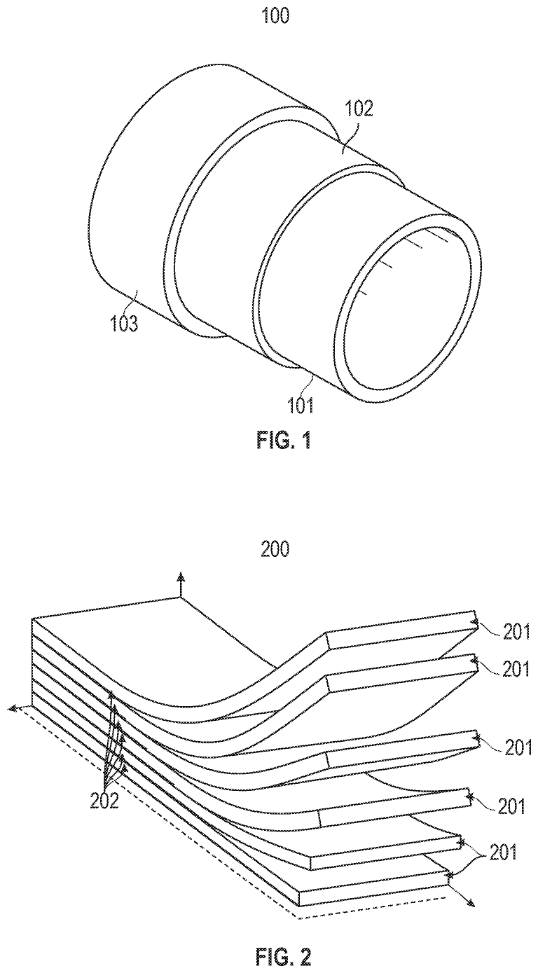

FIG. 2 is a diagram that illustrates an exemplary reinforcement layer structure 200 of thermoplastic composite pipe or pressure vessel 100 according to one or more embodiments. The exemplary reinforcement layer structure 200 may be formed from multiple layers of UHMWPE tape 201, and each layer of the UHMWPE tape 201 may be a composite formed from multiple UHMWPE film layers, described further below. In some embodiments, low melting bond layers 202 may be added between the tape layers and/or on the lowermost tape layer to promote bonding of the tape layers to one another or the internal liner. In various embodiments, functional materials may be added or may be additionally added intermediate to the tape layers or the lowermost or uppermost tape layer. When used, the bond layers and functional materials may be the same or different between each tape layer.

### Tape Structure

As noted above, one or more reinforcement layers of UHMWPE tape are formed from two or more UHMWPE film layers. The film layers may be bonded or unbonded, including self-bonding film layers or film provided with a bonding material disposed on one or both primary surfaces of a film layer or intermediate two or more of the film layers. Similarly, a functional material may be provided within a film layer or between film layers.

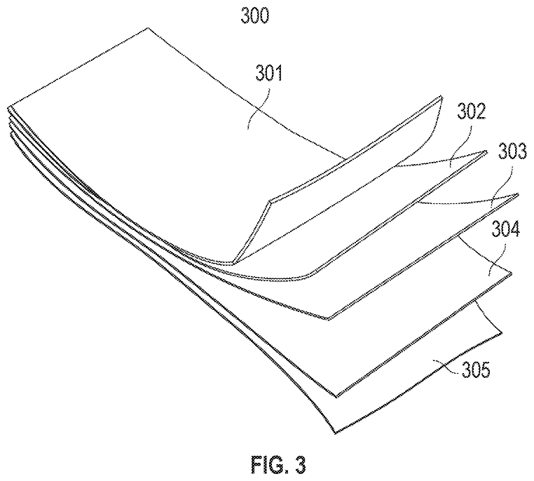

FIG. 3 is a diagram that illustrates an exemplary tape layer structure 300 useful in a UHMWPE tape 201 according to one or more embodiments. Each tape layer may include one or more UHMWPE film layers 301, 303, and 305. In some embodiments, low melting bond layers 302, and 304 may be added between the film layers and/or on the uppermost or lowermost film layer(s) to promote bonding of the tape layers to one another or an adjacent surface, such as another tape layer, another reinforcement layer, or the internal liner. In various embodiments, functional materials may be added or may be additionally added intermediate to the film layers or the lowermost or uppermost film layer. One or more functional materials may be added in the bond layers 302, and 304. When used, the bond layers and functional materials may be the same or different between each film layer.

As illustrated in FIGS. 2 and 3, the reinforcement structure may be formed from a multitude of tape layers, and the tape layer may be formed from a multitude of thinner self-reinforced UHMWPE film layers. Overall, the reinforcement structure may have a thickness of at least 20 microns. For example, the reinforcement structure may have a thickness in the range from about 20 microns to about 20000 microns, such as in a range from about 250 microns to about 3000 microns or from about 500 microns to about 2000 microns. For example, the thinnest reinforcement structure may have a thickness of 20 microns, whereas the thickest reinforcement structure may have a thickness of 20,000 microns. The thickness of the reinforcement structure may depend on the application's needs. For a non-limiting example, a pressure vessel may have a reinforcement structure with 20,000 microns thickness for having ballistic impact resistance or preventing penetration by ballistic fragments. For another non-limiting example, composite pipes have smaller diameters, and high spoolability may have a reinforcement structure with 250 microns thickness, or less.

Each reinforcement structure layer may be formed from one or more UHMWPE tape layers. Each UHMWPE tape layer may have a thickness of at least 20 microns. For example, each UHMWPE tape layer may have a thickness in the range from about 20 microns to about 500 microns, such as in the range from about 100 microns to about 300 microns. Each UHMWPE tape layer may have a width in the range from about 1 micron to about 250 microns, such as in a range from about 10 microns to about 150 microns, for example.

Each UHMWPE tape layer may be formed from two or more UHMWPE film layers, such as 2, 3, 4, 5, 6, 7, 8, 9, 10, or more film layers. Each UHMWPE film layer may have a thickness of at least 10 microns. Each UHMWPE film layer may have a thickness in the range from about 10 microns to about 100 microns. For a non-limiting example, each UHMWPE film layer may preferably have a thickness in the range from 20 microns to about 75 microns.

To form a multi-layered tape layer having a specific thickness, a stack of UHMWPE film may be combined to form a composite tape layer having a thickness of at least 20 microns, at least 50 microns, or at least 100 microns. The UHMWPE film may be stacked in a unidirectional way exactly on top of each other, or by roof tile or brick construction in order to form a tape wider than the individual UHMWPE films. Gaps or overlaps between unidirectionally oriented UHMWPE films may be deliberately stacked on top of each other (for welding purposes) or distributed evenly over the surface of the composite tape layer. The width of a UHMWPE film may affect the angle of winding, and therefore the width may be smaller for pipes having a smaller diameter or a greater angle of winding. For the processing of composite pipes and pressure vessels according to embodiments herein using the invented tape composite layer, the width may be at least 1 mm, such as in the range from 1 mm to 250 mm for example.

The UHMWPE films can be stacked or combined to form the tapes by hot lamination, gluing, welding, fusing, taping, stitching, weaving, or other methods known in the art. For example, the individual films that form a multi-layer tape can be bonded with the use of a resin located between the film surfaces, or by encapsulation of the multi-layered tape (no resin between films forming the tape). As a further example, the films can be combined in the multi-layered tape by use of a fiber, yarn, or film in such a way that the tape can be adequately processed during pipe manufacturing.

In the preferred embodiment of the invention, the tape made from a multitude of self-reinforced UHMWPE film may be combined with the use of heat and pressure. Creating a mechanical link between the individual film surfaces. Where the films are bonded together below the melting temperature of the reinforcing component. In particular, where the difference in melting temperature of a lower melting component and the reinforcement UHMWPE component increases upon application of tension. Such a lower melting component can be already present in the UHMWPE nascent powder, or can be applied to the surface of the nascent powder, or to the compacted sheet, or to the partly elongated body or to the self-reinforced UHMWPE film (fully elongated body), or can be applied to the films during the tape making process.

In various embodiments, a lower melting component may be present at least on one of the two outer surfaces of the tape. Such a lower melting component may be already present on the film or can be applied to the tape surface following suitable coating methods as described.

Suitable application methods of such lower melting component material may include but are not limited to calendaring, lamination, extrusion coating and co-extrusion, pull-trusion, hotmelt printing/spraying, dye-sublimation or dye-diffusion printing, powder coating and lamination, film lamination, dispersion coating, knife-coating, polymerization, degradation by irradiation, or combinations of such.

UHMWPE used to form the film layers and tape layers of the reinforcement structure may have a weight average molecular weight of at least 0.5 or at least more than 2, more preferably at least 4, even more preferably higher than 8 million grams per mole. For an example, UHMWPE used to form the film layers and tape layers of the reinforcement structure may have a minimum weight average molecular weight of 0.5 million grams per mole. For another example, UHMWPE used to form the film layers and tape layers of the reinforcement structure may have a maximum weight average molecular weight of 10 million grams per mole.

UHMWPE according to some embodiments herein may have a number average molecular weight greater than 0.5 million gram/mol, such as greater than 2, greater than 4, or greater than 5 million gram/mol. For an example, UHMWPE according to some embodiments herein may have a minimum number average molecular weight of 0.5 million gram/mol. For another example, UHMWPE according to some embodiments herein may have a maximum number average molecular weight of 6 million gram/mol.

During the manufacturing of composite pipes and pressure vessels, the molecular weight may determine the creep resistance for UHMWPE films having similar processing conditions and mechanical properties. As used herein, “creep resistance” may be defined as a resistance to a time-dependent deformation at elevated temperature and constant stress.

Molecular weights may be determined, for example, in accordance with ASTM D 6464-99 at a temperature of 160° C. using 1-chlorobenzene as a solvent. For determination of the average molecular weight greater than two million g/mol, rheology can also be used as for example described in Talebi et al. (Macromolecules, 2010, 43, 2780-2788; DOI:10/1021/ma902297b); the method may also provide an estimation of polydispersity. Prior to the measurements, the polymer powders may be first compressed at 125° C. and 100 bars for a total of 30 minutes. Due to the high sample stiffness, parallel plate geometry may be used with a disk diameter of 12 mm. The typical sample thickness may be at least 0.5 mm. For example, the typical sample thickness may be in the range from 0.5 to 1 mm. From the sintered powder, using a punching device, a disk of 12 mm diameter may be cut. The disk may then be carefully placed between the 12 mm geometries and heated fast (˜30° C./min) to above the equilibrium melting temperature in the rheometer (160° C. and kept constant throughout the rheological measurement) using a stress-controlled discovery hybrid Rheometer 20/30 equipped with a forced convection oven running under nitrogen environment. Under a constant axial force of 4 N (and kept constant throughout the rheological measurement), the LVE region may be established where typically the strain in the LVE may be between 0.1 and 0.3%. An oscillatory shear measurement in the linear LVE regime may be performed at 160° C. to equilibrate the polymer. Once the storage and loss moduli do not change as a function of time in the melt, a frequency sweep may be performed. For the high molar mass materials, a creep experiment may be performed to expand the frequency window of the measurements. Creep and frequency sweep experiments may be performed by applying strain amplitude in the LVE regime. The frequency sweep data may be fit using the TA Orchestrator software to estimate the weight average molecular weight Mw and the number of average molecular weight.

UHMWPE films useful in embodiments herein may have a tensile strength of at least 0.42 GPa and a modulus of at least 22 GPa, wherein the tensile testing may be determined in accordance with ASTM D882-00 using a strain rate of 50% per minute and the modulus may be determined in accordance with ASTM D822-00. In other embodiments, the UHMWPE films used to form the tape layers may have a tensile strength of at least 1.6 N/tex, at least 2.5 N/tex, at least 3.0 N/tex, or at least 3.5 N/tex as determined in accordance to ASTM D7744-11. In other embodiments, the UHMWPE films used to form the tape layers may have a modulus of at least 140 N/tex or at least 160 N/tex as determined in accordance to ASTM D7744-11.

In some embodiments, the UHMWPE films may be produced according to the process described in WO2009153318A1 and have a crystalline phase with uni-axial planar orientation. For a non-limiting example, the process for manufacturing a film of ultra-high molecular weight polyethylene may include the steps of subjecting a starting ultra-high molecular weight polyethylene in powder form to a compacting step, subsequently, subjecting the compacted UHMWPE to a rolling step and at least one stretching step under such conditions that at no point during the processing of the polymer its temperature may be raised to a value above its melting point. Other methods of sintering known to one skilled in the art may be followed to replace this specific processing step. The uni-axial planar orientation parameter may be here defined as the peak area ratio between the equatorial crystal planes with Miller indices 200 and 110 from the X-ray diffraction (XRD) pattern of the film or tape as determined in reflection geometry. The method may be described in WO2009007045A1.

### Bonding Material

As noted above, the tapes are formed from one or more UHMWPE film layers that may include a bonding material intermediate of one or more of the film layers. At least one of the UHMWPE film layers may include, internally (co-extruded, or self-bonding) a mixture of UHMWPE and a polyethylene or polyethylene copolymer having a lower melting point than the UHMWPE, or externally a polyethylene or polyethylene copolymer disposed on a surface of the UHMWPE film.

The bonding material may be a lower melting component, allowing for heat, pressure, or other effects to initiate a bond between the two adjacent UHMWPE layers. With reference to the UHMWPE film, the lower melting component may be selected from polyethylene having lower molar mass to allow easy recycling, for example. In some embodiments, the lower melting component may include, for example, disentangled polyethylene, high-density polyethylene HDPE, medium-density PE MDPE, or other various grades of polyethylene. In some embodiments, the lower melting component may include polybutadiene or polyolefine co-polymers and blends of such polymers.

The UHMWPE films used in some embodiments can be fully or partly covered with the lower melting component, where the coverage can be in a specific pattern or has a more randomly scattered nature. In yet another embodiment, the lower melting component may be concentrated at the film edges. Next to lamination of an open web or by powder-coating, the surface of UHMWPE films can be partly covered with lower melting component material by co-stretching. For example, a coated layer of fewer than 50 micrometers may be stretched over 2 times its original length during the solid-state processing of the UHMWPE film. The lower melting component might be partly oriented parallel to the length of the reinforcing UHMWPE film component, where this orientation can be determined by a person skilled in the art, for example by using Raman spectroscopy or X-ray diffraction techniques. Co-stretching offers an economical route to apply bonding and further functional materials to the film and subsequent tape.

### Functional Material

In one or more embodiments, a tape may be produced by combining functional organic or inorganic materials with the self-reinforced UHMWPE film to form a functional tape. In one or more embodiments, the functional materials may be applied to the surface of at least one of the UHMWPE films or tapes or may be encapsulated in between at least two films or tapes. In one embodiment of the invention, more than one such as two, three, four, or more types of functional materials may be present in the film, and, or in the tape, and, or in the thermoplastic composite pipe or the pressure vessel. A thermoplastic composite pipe or pressure vessel may also be made of different types of tape, where at least one tape may be functional. Even further, the organic or inorganic materials can also be added as an individual layer during the winding of one or more different tapes during the pipe manufacturing process. The functional material might also be present in the UHMWPE, or a functionalized polyethylene macromolecule can be mixed with the UHMWPE powder prior to the film making, or a functionalized polyethylene macromolecule can be applied to the surface of the UHMWPE film. For example but not limited to functional polar groups to improve wetting, bonding or cross-linking of the UHMWPE film or tape.

The organic or inorganic material may be, for example, in the form of oriented or randomly oriented filaments, short cut filaments, bi-component filaments, fibers, yarns, roving, wires, closed or partly opened or discontinuous film, or sheet, or tapes, web, woven or nonwoven, fabric, spacer fabric, scrim, powder, flakes, dots, lines, foams or a mix of such. The total functional materials content per total weight of the functionalized tape may be at least 0.5 wt %. The total functional materials content per total weight of the functionalized tape may not be restricted to but may be in the range from 0.5 to 50 wt % of the overall tape, for example.

In one or more embodiments, organic materials used as functional materials may include but are not limited to, polyolefin polymeric homopolymer, copolymer, block-copolymers, carbon, polyethylene, polyester, polyamide, para-aramid, meta-aramid, polyvinyl butyral, polyurethane, PVDF, PPS, PEEK, PAEK, and aliphatic polyketones, elastomers, thermoset resin UV curable resin, graphene or graphene-oxides, combinations of such, and may have further functional fillers including carbon black, mineral fillers, and nanoparticles.

In some embodiments, an inorganic functional material may be selected from but is not limited to glass, aluminum, copper, corrosion-resistant metallic alloys, titanium, steel, basalt, and any combinations thereof. In one or more embodiments, piezoelectric materials and electric conductive inks may be used as functional materials.

In some embodiments, a first or primary functional material can be supplied with a secondary functional material. For example, the lower melting component can be modified with one or more fillers that may improve the manufacturing and processing of and the performance of the final pipe or pressure vessel (for example improved resistance to creep deformation). For example, mineral fillers may be used to improve the heat deflection temperature by constraining the amorphous phase. Other fillers known in the art of film processing may be used in forming tapes useful in embodiments herein. In some embodiments a first functional material may be supplied on at least one surface of the UHMWPE tape or film before a second functional material may be applied. For example to reduce the contact angle, in order to improve wetting of UHMWPE by polar or hydrophilic matrices.

Co-extrusion of a multilayer of different functional materials to combine with the UHMWPE film may be also considered. For example, a thin sheet of inorganic aluminum can be included. For the purpose of good bonding, the aluminum can be single or double side extrusion coated with an organic polymer, such as polyethylene.

In another embodiment, filaments are coated at least partly with a hot polymeric material and directly sandwiched in between two self-reinforced UHMWPE films. The UHMWPE film may have a high thermal conductivity to withstand short exposure to temperatures above the melting point. The filaments can also be coated with a lower melting component and bonded to at least one of the UHMWPE films and subsequently laminated or calendared at high temperatures below the melting temperature to form the functional composite tape layer.

In yet another embodiment, the functional material may be embedded or pre-coated in a “partially cured” thermoset resin, having a curing temperature below the melting temperature of the UHMWPE film. Once embedded in the desired position in the film, tape, and pipe curing are allowed by the application of heat or catalyst.

For the pipe-making process according to embodiments herein, a conductive heat source or a radiation heat source can be used to generate the heat required for bonding. It may be envisioned that the application of a conductive heat source and a radiation heat source may be combined. In some embodiments, heat sufficient for bonding may be applied or induced at only a small surface area of the film and only for a short time. The UHMWPE film may be a good heat conductor that allows short-time high-temperature exposure when kept under tension.

In another embodiment, no resin may be applied to combine the functional material with the UHMWPE film or with the tape and pipe articles made from them. As an example of such a resin-free reinforced thermoplastic composite layer, a functional material in the form of unidirectionally oriented filaments may be located between two UHMWPE films. To create an effective containment of the filaments, at least one of the UHMWPE films may have a lower melting component for thermal binding purposes.

In one or more embodiments, light-absorbing fillers are used to aid the welding process during pipe manufacturing. As known to the person skilled in the art, carbon black fillers are a well-known example of such light-absorbing fillers. Such a filler may be preferably concentrated at the surface of the tape in the lower melting component.

In one or more embodiments, the functional material may be selected to have a low permeability towards gases such as H₂S, CO₂, and CH₄, or other gases commonly encountered in oil and gas operations. In another embodiment, the functional material may be selected on the basis of having low solubility toward aromatic hydrocarbon compounds such as toluene, benzene, ethylbenzene, and xylenes. In one or more embodiments, the functional material may be used to form a specified pattern that can be registered from outside of the pipe or pressure vessel via radio signals, and Xrays.

As described above, in some embodiments the functional material may include oriented or randomly oriented filaments, short-cut filaments, bi-component filaments, fibers, yarns, roving, wires, closed or partly opened or discontinuous film/sheet/tapes, web, woven or nonwoven, fabric, spacer fabric, scrim, powder, flakes, dots, lines, foams, or a combination of two or more of these.

In other embodiments, the functional material may include polyolefin polymeric homopolymer, copolymer, block-copolymers, carbon, polyethylene, polyester, polyamide, para-aramid, meta-aramid, polyvinyl butyral, polyurethane, PVDF, PPS, PEEK, PAEK, and Aliphatic Polyketones, elastomers, thermoset resin UV curable resin, graphene or graphene-oxides, carbon black, short filaments, mineral fillers, nanoparticles, and combinations of two or more of these.

In still other embodiments, the functional material may include glass, aluminum, copper, corrosion-resistant metallic alloys, titanium, steel, basalt, piezoelectric materials, electric conductive inks, or combinations of two or more of these.

One or more tape layers can be wound over an inner liner at a specific angle known to a person skilled in the art of making pipe or pressure vessels from tape articles. Where the angle with regard to the extension direction of the article may be defined as follows. It may be the angle between the extension direction of the tapes and the extension direction of the article. In a curved article, the extension direction follows the curvature of the article. Where the article may be straight, the extension direction may be the main extension direction of the article.

The tape layer(s) may be tightly wound around the inner liner using any method apparent to one of ordinary skill in the art with a winding angle ranging from a parallel 0 to perpendicular 90 with respect to the extension direction of the article. In one or more embodiments, the winding angle (helix angle, or angle relative to a line perpendicular to an axis of the hollow inner liner) may be in the range from about +/−90 to about +/−90 degrees, for example with a lower limit of any of +/−90 degrees, +/−80 degrees, or +/−70 degrees to an upper limit of any of +/−70 degrees, +/−80 degrees, or +/−90 degrees, where any lower limit may be used in combination with any upper limit. This winding angle may vary for different tapes and for different locations of the article. The winding angle may vary depending on the diameter of the inner liner, the thickness of the reinforcement structure, and the width and thickness of the tape layer. In the case of pressure vessels or complex hollow pressure vessel articles, the winding angle may change over the surface.

One or more tape layers may be wound around the inner liner to a thickness of at least 20 micros. For example, one or more tape layers may be wound around the inner liner to a thickness in the range of 20 microns to 20 mm. For a non-limiting example, for constructing a composite pipe, a UHMWPE film may have a thickness of 10 microns, a tape layer having two UHMWPE films may have a thickness of 20 microns, and a reinforcement structure having a single tape layer may have a thickness of 20 microns. For another non-limiting example, for constructing a pressure vessel, a UHMWPE film may have a thickness of 100 microns, a tape layer having five UHMWPE films may have a thickness of 500 microns, and a reinforcement structure having four tape layers may have a thickness of 2000 microns.

In another embodiment, the functional thermoplastic composite tape may have a self-health monitoring capability as provided by integrated functionalities into the pipe to allow action before failure. This may include, but may not be limited to, local stress/strain, deformation, layer separation, dislocation, temperature and humidity, gas and liquid hydrocarbon sensing via for example reactive indicators, printed sensory, and tracers. In another embodiment, such measurements are recorded (in real-time or frequent basis) and used as part of a structural integrity management system to assess fitness-for-service and remaining life. In another embodiment, such measurements can be used as part of a digital twin model of the physical pipe or pressure vessel.

The functionalities can either be combined with the tape or be positioned in between tapes during the winding of the pipe manufacturing process. In another embodiment, one layer may be the self-reinforced UHMWPE film and a second functional layer may be wound in the same direction, or clock-wise—counter clock-wise, in the same or at another winding angle. Not necessarily, the functional or reinforcement layer may be bonded, where this can be effectively encapsulated, where this decoupling of reinforcement can be considered as a functionality, for example, to aid better spooling of the pipe.

In yet another embodiment, the air permeability of at least one layer allows gas or liquid to flow in a direction of interest. Such flow can be used to cool or heat the pipe, to suction a harmful gas to a safe collection point, or allow to transport of a tracer or marker. Carbon-based nanotube additives are envisioned to enhance thermal conductivity further and or the electrical conductivity of the self-reinforced UHMWPE bodies.

### Cover Layer

A cover layer may be useful to protect the reinforcement layer from external damage including UV aging, external fluid ingress, and impact resistance. Depending on the application, the cover layer may or may not be required. Cover layers according to embodiments herein may be formed from natural or synthetic rubbers or other man-made polymers as known in the art. The polymers used to form the cover layers or a layer thereof may be selected based on the properties of the environment into which the pipe or pressure vessel may be to be disposed of, the material to be conveyed or handled in the composite pipes and pressure vessels, desired flexibility or bending radius of the composite pipes, or other properties of the overall composite pipes and pressure vessels according to embodiments herein.

In some embodiments, cover layers useful in embodiments herein may be formed from various thermoplastic polymers, such as polyethylene (Ultra High Molecular Weight Poly-Ethylene, High-Density PE, Medium Density PE, PE, PE-copolymers, etc.), polypropylene or polypropylene copolymers, polyamides such as PA6, PA11 and PA12, and other various thermoplastics. In other embodiments, cover layers useful in embodiments herein may be formed from polyvinyl fluoride, polytetrafluoroethylene, polyimides, polymethyl methacrylate, polycarbonate, polyketones, polyether-ether ketone, polyvinyl chloride, chlorinated polyvinyl chloride, but may not be limited to the above examples. Thermoplastic materials may have a uniform nature or a molecular orientation.

### Overall Pipe or Pressure Vessel Properties

The various properties of the internal liner, the reinforcement structure, and the cover layer may vary based on the final desired properties of the overall pipe or pressure vessel. For example, UHMWPE molecular weight, film thickness or width, tape thickness or width, number of layers of film per tape, number of tape layers per reinforcement structure layer, number of reinforcement layers, bonding material type, amount and location, functional material type, amount, and location, and other factors may be varied to achieve a pipe or pressure vessel having a suitable barrier, pressure, and temperature rating. The reinforcement layer containing sufficient UHMWPE tape can present protection against high-velocity fragments or projectile penetrating the pipe or pressure vessel.

In some embodiments, thermoplastic composite pipes and pressure vessels may be configured to operate at temperatures of up to about 85° C. and pressure of up to 20.7 MPa. In one embodiment of the invention, a pipe diameter of about 152 mm (6 inches) can bear about 15 Mpa (2250 psi) at about 82 C (180 F). In another embodiment of the invention, a pipe diameter of about 254 mm (10 inches) can bear about 20.7 Mpa (3000 psi) at about 85 C (185 F). In yet another embodiment of the invention, a pressure vessel of about 380 mm in diameter (approximately 800 mm in length) can bear about 20.7 MPa of pressure at about 85 C (358 K).

As described above, embodiments herein may provide a new generation of cost-effective and environmentally friendly thermoplastic composite pipes and pressure vessel technologies as viable solutions for the replacement of carbon steel flowlines with integrated functionalities (e.g., self-monitoring).

In one or more embodiments, the thermoplastic composite pipes and pressure vessels may further include integrated electronics, tracers, and indicators configured for use in quality inspection of the pipes and or pressure vessels during operational service. For an example, tracers may be used for detecting structural defects before failure, integrated electronics may allow the real-time measurement to form a digital twin of the real pipes or vessels.

Unless defined otherwise, all technical and scientific terms used have the same meaning as commonly understood by one of ordinary skill in the art to which these systems, apparatuses, methods, processes, and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” is used, this term may mean that there can be a variance in the value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having the benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A reinforced thermoplastic composite pipe or pressure vessel, the reinforced thermoplastic composite pipe or pressure vessel comprising:
an elongate tubular body having an outer surface; and
at least one reinforcement layer disposed on the outer surface of the elongate tubular body,
wherein the at least one reinforcement layer comprises one or more layers of ultra-high molecular weight polyethylene (UHMWPE) tape, and wherein the UHMWPE tape is a composite comprising multiple UHMWPE film layers.

2. The reinforced thermoplastic composite pipe or pressure vessel of claim 1, further comprising a cover layer positioned as the outermost layer.

3. The reinforced thermoplastic composite pipe or pressure vessel of claim 1, wherein the UHMWPE tape has a thickness in the range of 20 microns to 500 microns.

4. The reinforced thermoplastic composite pipe or pressure vessel of claim 3, wherein the UHMWPE tape comprises one or more UHMWPE film layers, each film having a thickness in the range from 1 to 100 microns.

5. The reinforced thermoplastic composite pipe or pressure vessel of claim 1, wherein the UHMWPE film layers comprises UHMWPE having a weight average molecular weight in the range from 0.5 to 10 million grams/mol.

6. The reinforced thermoplastic composite pipe or pressure vessel of claim 1, wherein the UHMWPE film layers comprises UHMWPE having a number average molecular weight in the range from 0.5 to 6 million grams/mol.

7. The reinforced thermoplastic composite pipe or pressure vessel of claim 1, wherein the UHMWPE film layers have a tensile strength of at least 0.42 GPa and a modulus of at least 22 GPa as determined in accordance with ASTM D882-00 using a strain rate of 50% per minute and the modulus is determined in accordance with ASTM D822-00.

8. The reinforced thermoplastic composite pipe or pressure vessel of claim 1, further comprising a bonding material, a functional material, or both, disposed intermediate at least two of the UHMWPE film layers or disposed intermediate at least two of the UHMWPE tape layers, or both.

9. The reinforced thermoplastic composite pipe or pressure vessel of claim 8, wherein the bonding material comprises a polyethylene or polyethylene copolymer having a lower melting point than the UHMWPE film.

10. The reinforced thermoplastic composite pipe or pressure vessel of claim 8, wherein the bonding material, and, or the functional material is configured to aiding the welding or gluing process during tape winding or placing process.

11. The reinforced thermoplastic composite pipe or pressure vessel of claim 8, wherein the functional material is configured to embedding, fixing or containing a second reinforcement material.

12. The reinforced thermoplastic composite pipe or pressure vessel of claim 8, wherein the functional material is configured to forming a high strength high stiffness matrix or resin to reinforce the reinforced thermoplastic composite pipe or pressure vessel.

13. The reinforced thermoplastic composite pipe or pressure vessel of claim 8, wherein the functional material is configured to preventing cracking or splitting of the reinforcement layer.

14. The reinforced thermoplastic composite pipe or pressure vessel of claim 8, wherein the functional material is configured to retaining strength and modulus upon heating the reinforced thermoplastic composite pipe or pressure vessel to a high temperature of at least 60° C.

15. The reinforced thermoplastic composite pipe or pressure vessel of claim 8, wherein the functional material is configured to enhancing barrier properties towards gases including H₂, H₂S, CO₂, CH₄, and NH₃ and aromatic hydrocarbons including toluene, benzene, ethylbenzene, and xylene.

16. The reinforced thermoplastic composite pipe or pressure vessel of claim 8, wherein the functional material comprises oriented or randomly oriented filaments, short-cut filaments, bi-component filaments, fibers, yarns, roving, wires, closed or partly opened or discontinuous film/sheet/tapes, web, woven or nonwoven, fabric, spacer fabric, scrim, powder, flakes, dots, lines, foams, or a combination of two or more of these.

17. The reinforced thermoplastic composite pipe or pressure vessel of claim 8, wherein the functional material comprises polyolefin polymeric homopolymer, copolymer, block-copolymers, carbon, polyethylene, polyester, polyamide, para-aramid, meta-aramid, polyvinyl butyral, polyurethane, PVDF, PPS, PEEK, PAEK, and Aliphatic Polyketones, elastomers, thermoset resin UV curable resin, graphene or graphene-oxides, carbon black, short filaments, mineral fillers, nanoparticles, and combinations of two or more of these.

18. The reinforced thermoplastic composite pipe or pressure vessel of claim 8, wherein the functional material comprises any of the following: glass, alumina, trimethylaluminum (TMA), copper, copper-polydopamine, corrosion-resistant metallic alloys, titanium, steel, basalt, flame-resistant materials, piezoelectric materials, electric conductive inks, or combinations of two or more of these.

19. The reinforced thermoplastic composite pipe or pressure vessel of claim 1, wherein at least one of the UHMWPE film layers comprise a mixture of UHMWPE and a polyethylene or polyethylene copolymer having a lower melting point than the UHMWPE film such that the lower melting temperature component is concentrated most highly on at least one of the two larger surfaces of the film.

20. The reinforced thermoplastic composite pipe or pressure vessel of claim 1, wherein the elongate tubular body and the reinforcement layers are constructed with a single polymeric material for easy processing and recycling.

21. The reinforced thermoplastic composite pipe or pressure vessel of claim 1, wherein the reinforcement layer is configured to protecting the reinforced thermoplastic composite pipe or pressure vessel from penetration by a high-velocity fragment or a projectile.

22. The reinforced thermoplastic composite pipe or pressure vessel of claim 1, wherein at least one of the UHMWPE film layers comprise a mixture of UHMWPE and a functionalized polyethylene macromolecule.

23. The reinforced thermoplastic composite pipe or pressure vessel of claim 22, wherein the functionalized polyethylene macromolecule is configured to improving wetting, bonding, and, or cross-linking of the reinforced thermoplastic composite pipe or pressure vessel.

24. A method of forming a reinforced thermoplastic composite pipe, comprising:
extruding an elongate tubular body having an outer surface;
wrapping at least one reinforcement layer on the outer surface of the elongate tubular body; and
positioning a cover layer as the outermost layer,
wherein the at least one reinforcement layer comprises one or more layers of ultra-high molecular weight polyethylene (UHMWPE) tape, and wherein the UHMWPE tape is a composite comprising multiple UHMWPE films.

25. The method of claim 24, further comprising integrated electronics, tracers, and indicators configured for using in quality inspections.
